(19) United States
(12) Patent Application Publication
(10) Pub. No.: US 2013/0015671 A1
(43) Pub. Date: Jan. 17, 2013

(54) SELECTIVELY DISENGAGEABLE AND COUPLABLE HANDLE WITH MOTOR

(71) Applicant: Johan Calleberg, Goteborg (SE)

(72) Inventor: Johan Calleberg, Goteborg (SE)

(21) Appl. No.: 13/636,549

(22) PCT Filed: Mar. 23, 2011
(86) PCT No.: PCT/SE2011/050322

§ 371 Date: Sep. 21, 2012

(30) Foreign Application Priority Data
Mar. 23, 2010 (SE) 1050275-5

(51) Int. Cl. E05C 1/06; E05B 47/00

(52) U.S. Cl. 292/144

(57) ABSTRACT

Handle device for doors, windows etc, comprising a first rotatable element (1), and a second element (3), and a coupling device. The coupling device comprises an axially movable activating member (30), and at least one engaging member (51, 52) which can be radially moved between release- and engagement positions. In release position, the first and second (1, 3) elements are mutually rotatable. In engagement position, rotation is prevented. An electric motor (21) moves the activating member (30). It has an output shaft (22) rotatable in two opposite directions and a threaded shaft portion (25) with a first thread. The activating member (30) has a thread engagement portion (34) having a second thread corresponding to the first thread of the shaft (22). First and second spring members (41, 42) press the thread engagement portion (34) towards the threaded shaft portion of the shaft, when the first and second threads are disengaged by rotation of the shaft (22).

### FIELD OF THE INVENTION

The invention relates generally to a handle device for operating doors, windows, gates, hatches and the like. The invention relates in particular to such a handle device comprising a first element, which is rotatable about an axis of rotation, a second element, and a coupling device for selectively allowing or preventing relative rotation about the axis of rotation between the first element and the second element. The invention has a use, for example, on doors, windows and the like that are to be able to be operated using some type of handle, for example a lever handle, a thumb turn or a handle of the window handle type.

### BACKGROUND OF THE INVENTION

In many doors, windows and other such elements provided with a rotatable handle, it is desirable that a part that can be turned or rotated by means of the handle can be selectively coupled to or disengaged from another part. The other part can either be a similarly rotatable part or a stationary part.

When both parts are rotatable, it may be desirable in a disengaged position, for example, to allow the handle to be turned without affecting the other part and, in a coupled position, to allow a rotation movement of the handle to be transferred to the other part. The other part can then be, for example, a swivel pin, such as a handle shank or lever handle shank, which is in turn able to transfer the rotation movement to a follower, a bolt, an espagnolette, a lock or some other device for influencing the state of the door or of the window. In the coupled position, normal operation therefore occurs by way of the handle. In the disengaged position, by contrast, the state of the door or of the window remains unaffected if the handle is turned.

Disengagement of the handle from another rotatable part is sometimes referred to as “free swing”. This kind of selective disengagement can be used, for example, as a child safety measure, in order to prevent an external door or a window from being opened from the inside, or in order to prevent damage to a lock or the like coupled to the handle if excessive forces are applied to the handle when the lock is in the locked position.

When the other part is a stationary, non-rotatable part, the rotatable handle can be conventionally fixed or continuously coupled by means of a handle shank or lever handle shank to a bolt, an espagnolette, or a lock, for example, or some other device for influencing the state of the door or the window. Disengagement and coupling between the rotatable handle and the stationary part can then be used, in the disengaged position, to allow operation and, in the coupled position, to block the handle and thereby prevent operation of the door or the window. The coupling between the handle and the stationary part can in this respect be said itself to constitute a lock. This kind of selective disengagement and coupling between the rotatable handle and the stationary part can be used as a child safety measure, for example, or in order to prevent unauthorized persons from operating a door or a window.

In both cases the disengagement and coupling between the rotatable handle and the other part can be achieved manually, for example by operating a mechanical button, a lock cylinder or the like. Recently, however, it has become increasingly more common to bring about this disengagement and coupling by electromechanical means. This allows disengagement and/or coupling, for example, only when an authorized user has first entered a code via a keypad or has provided an identification via a card reader for electronic cards.

### PRIOR ART

WO 2009/078800 describes a handle device with which it is possible to selectively disengage and couple a first rotatable element and a second element. The first element can be, for example, a handle grip, and the second element can be a handle plate. The device comprises an inner coupling member and an outer coupling member and also an engaging member. By moving an activating member axially, it is possible for the engaging member to be placed in and removed from simultaneous engagement with the inner and outer coupling members. When the engaging member is in simultaneous engagement with both coupling members, relative rotation between them is prevented. When the engaging member is removed from simultaneous engagement, relative rotation of the two coupling members is permitted. Axial movement of the activating member is obtained manually or by means of an electrically driven solenoid.

### SUMMARY OF THE INVENTION

An object of the invention is to make available an improved handle device which permits selective disengagement and coupling between a first rotatable element and a second element.

Another object is to make available a handle device of this kind that can be configured with small dimensions and has a small axial installation size.

A further object is to make available a handle device of this kind that requires low electrical energy.

Yet another object is to make available a handle device of this kind that has a high degree of safety and an improved ability to withstand unauthorized manipulation.

A further object is to make available a handle device of this kind that permits relatively simple electrical control.

Yet another object is to make available a handle device of this kind that has a high level of operating safety and a long lifetime.

Another object is to make available a device of this kind that is simple, with few movable parts, and yet permits very secure coupling between the two elements.

These and other objects are achieved by a handle device of the type that is specified in the introductory part of claim 1 and that has the special technical features specified in the characterizing part. The handle device is suitable for operating doors, windows and the like. The handle device comprises a first element, which is rotatable about an axis of rotation, a second element, and a coupling device. The coupling device comprises an activating member, which is axially movable parallel to the axis of rotation, and at least one engaging member which, by means of the activating member, can be moved radially between a release position and an engagement position. In the release position, the first and second elements are rotatable in relation to each other about the axis of rotation. In the engagement position, relative rotation between the first and second elements is prevented. The coupling device also comprises an electrical drive device for moving the activating member to and fro axially. The electrical drive device comprises an electrically driven motor with an output shaft rotatable in two opposite directions of rotation, which shaft comprises a first end portion and a second end portion and, arranged between the end portions, a threaded shaft portion with a first thread. The activating member has a thread engagement portion with a second thread that corresponds to the first thread of the shaft. The first and second threads are designed to drive the activating member axially along the shaft during thread engagement and rotation of the shaft. The handle device also comprises a first spring member and a second spring member, which spring members are arranged to press the thread engagement portion of the activating member in the direction towards the threaded shaft portion of the shaft, when the second thread of the activating member has been disengaged from the first thread of the shaft by means of rotation of the shaft in a respective direction of rotation.

The handle device according to the invention permits selective disengagement and coupling between the first element and the second element. The first element can be a part of the handle or can be connected thereto in a rotationally fixed manner. Here, handle means all types of operating devices that can be gripped or otherwise manually acted on and rotated about an axis of rotation for the purpose of operating another movable member. Examples of such handles are lever handles, window handles, such as handles of the espagnolette type, thumb turns or knobs such as door knobs. The invention therefore permits selective disengagement and coupling between the handle and the second element. The second element can be rotatable or non-rotatable. The engaging member can adopt a release position, in which the first element is not coupled to the second element. In this position, therefore, relative rotation is permitted between the first and second element. By moving the axially movable activating member, it is possible to move the engaging member radially to an engagement position, such that the first element is coupled to the second element.

By virtue of the fact that an electrically driven motor is used to provide the axial movement of the activating member, the coupling device can have vey small installation dimensions. The use of an electric motor means that the length of the device in the axial direction can be reduced considerably in relation to previously known devices of this kind. This permits, for example, a considerable reduction in the extent to which the whole handle device extends out from the door or the like on which it is mounted. When the handle device is used on handles comprising a handle neck, the length of the handle neck can be reduced correspondingly.

In the arrangement according to the invention, with a threaded shaft portion arranged on the output shaft of the motor, with a corresponding thread engagement portion arranged on the activating member, and with spring members for pressing the activating member in the direction towards the threaded shaft portion, a number of advantages are afforded. The motor is driven in a first direction of rotation in order to drive the activating member in a first axial direction until the thread engagement portion on the activating member has passed the threaded shaft portion, such that the activating member is disengaged from the shaft. One spring member presses the activating member in the direction towards the threaded shaft portion, and the activating member, upon continued rotation in the first direction of rotation and with the shaft stationary, adopts a defined first end position. This first end position corresponds to the engaging member being located in a first radial position. When the motor is driven so as to rotate in the other direction of rotation, the first spring member presses the thread engagement portion of the activating member back into engagement with the threaded shaft portion, after which continued rotation in the other direction moves the activating member to a second defined end position at the opposite end portion of the shaft, where the thread engagement portion of the shaft has been disengaged from the threaded shaft portion and where the second spring member presses the activating member towards the threaded shaft portion. This second defined end position corresponds to the engaging member being located in a second radial position and being retained as long as the shaft is driven in the second direction of rotation or the shaft is kept stationary.

This allows the activating member to be moved between and held in two well-defined end positions, which end positions correspond to the respective radial positions of the engaging member. Moreover, this arrangement permits simple operation and control of the electric motor. The motor can, for example, be controlled in respect of the approximate time it takes to move the engaging member between the first and second end positions. If the motor is driven to rotate in either direction for longer than is needed to shift the activating member to a respective end position, the activating member, by virtue of having been disengaged and being under the action of the corresponding spring member, is maintained in the well-defined end position. Continued rotation of the motor does not cause the activating member to shift or risk the motor braking, being overloaded or jamming, which would otherwise be the case if the activating member was still in engagement when the activating member was held by mechanical means in the end position. The invention therefore has the effect, on the one hand, that the motor only needs to be controlled with low precision, which makes designing and producing the handle device easier and less expensive, and, on the other hand, that the motor does not risk being overloaded or being damaged in another way.

A further advantage of the activating member being driven by motor according to the invention is that, for example compared to solenoid operation, only relatively low electrical energy is needed to move the activating member between its end positions. This means, for example, that a small battery can be used to control and operate the handle device or that the battery life is extended. In addition, the motor operation according to the invention permits an improved possibility of controlling the function of the handle device. For example, it is possible, during the operation of the motor, to measure the current or power consumption of the motor in order thereby to detect if the motor is exposed to an abnormal mechanical resistance. Such resistance can arise, for example, if the activating member and/or the engaging member is prevented from adopting the intended position because of some abnormal obstacle or state. It is thus possible, for example, to detect if the engaging member has not adopted its engagement position after the motor has been operated so as to couple the two elements. This detection can be used, for example, to automatically control the motor to make a renewed attempt to bring the activating member and the engaging member to the intended position or to generate an error message which notifies the user that the intended state of the handle device has not been reached.

The first thread is expediently an external thread arranged on the threaded shaft portion, and the activating member expediently has an axial bore which receives the shaft and which, along the thread engagement portion, has the second thread in the form of an internal thread. This permits an extremely compact and functionally reliable construction with few movable parts.

The first and second spring members can each comprise a helical spring. This has the effect that the activating member is pressed in the direction towards the threaded shaft portion in an extremely simple, functionally reliable and compact manner.

The first and second spring members can, at a respective first end, be fixed to the activating member. This basically provides increased functional reliability, since it reduces the risk of the spring members failing and preventing movement of the activating member.

The activating member and the shaft can be accommodated in an inner coupling member, which is accommodated concentrically in an outer coupling member. This embodiment further contributes to a space-saving and functionally reliable construction.

The activating member can be received in a rotationally fixed manner in the inner coupling member. This ensures, in a simple and functionally reliable manner, that the activating member is moved axially by the intended distance when the motor is driven in rotation for a predetermined time.

The first element can be a handle grip, which is fixed to the inner coupling member, and the second element can be a handle plate, which constitutes or is fixed to the outer coupling member. This allows the handle device to be used to selectively block or permit rotation of the handle grip.

The first element can be a handle grip, which constitutes or is fixed to the outer coupling element, and the second element can be a rotatable swivel pin, which constitutes or is fixed to the inner coupling member. The swivel pin can in this case be coupled, for example, to a lock, an espagnolette or some other device with movable parts that can be maneuvered in order to prevent or permit the opening of, for example, a door or the like. This allows the handle device to be used in order to selectively provide free swing.

The engaging member or engaging members can comprise a respective ball. The ball or balls can be received in a respective radial, cylindrical hole in the inner coupling member. Alternatively, the engaging member can be a circular cylindrical pin, which is arranged in a recess in the inner coupling member, such that its axis extends parallel to the axis of rotation. Regardless of the design of the engaging members, the handle device can comprise more than one engaging member.

The activating member can have a surface which is inclined with respect to the axial direction of movement thereof and which, in contact with the engaging member, presses the latter radially outwards when the activating member is moved axially. This results in a reliable and easily operated transfer of movement with low friction.

The handle device expediently comprises an electrical control circuit for controlling the electric motor.

The electrical control circuit can be designed to drive the electric motor to rotate in a respective direction of rotation for a predetermined time, which time corresponds to movement of the activating member between a first end position and a second end position of the activating member. This permits extremely simple control and operation of the electric motor. By virtue of the design of the coupling device according to the invention, it is sufficient in this way to control the motor only with low precision.

The electrical control circuit can comprise means for measuring the current or power consumption of the electric motor. In this way, it is possible to detect any error function in the operation of the activating member.

The handle device can further comprise authorization-verifying means, preferably a keypad, which is electrically connected to the control circuit. In this embodiment, the selective disengagement and/or coupling can be achieved only after a correct authorization code has been entered. The electrical control circuit can additionally or alternatively be connected to an electronic card reader or similar authorization-verifying equipment. By virtue of the effective coupling device, with which an axial movement of the activating member can be converted with modest force into a radial engagement movement of the engaging member, all the parts and components for this authorization verification and electrical control of the device can be accommodated in a handle. This handle can either be one whose coupling to another element is controlled, or also the second of two opposite handles mounted on a door or the like.

Further objects and advantages of the invention will become clear from the following detailed description of an illustrative embodiment and also from the claims.

### BRIEF DESCRIPTION OF THE FIGURES

A detailed description of an illustrative embodiment is given below with reference to the attached figures, in which:

FIG. 1 is a cross section through a handle device according to an embodiment of the invention.

FIG. 2 is a partially exploded perspective view of some parts included in the handle device shown in FIG. 1.

FIG. 3 is a perspective view of some parts included in the handle device shown in FIG. 1.

FIGS. 4a-c are schematic cross sections, on an enlarged scale, of some parts included in the handle device shown in FIG. 1 and show these parts in different operating positions.

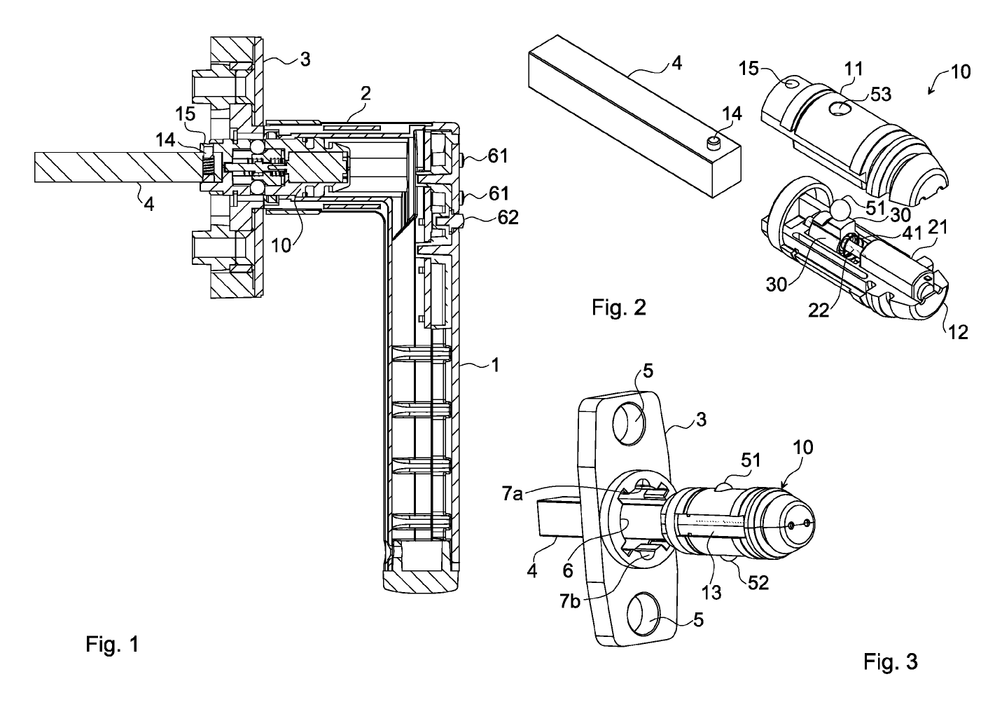

### DETAILED DESCRIPTION OF ILLUSTRATIVE EMBODIMENT

The figures show a handle device according to a first embodiment of the invention. This handle device is designed to permit selective disengagement and coupling between a handle grip and a stationary part which, in this example, is a handle plate. In the disengaged position, rotation of the handle grip is therefore permitted, and, in the coupled position, the handle grip is blocked against being turned in relation to the handle plate.

The handle device comprises a handle grip 1, a handle neck 2, a handle plate 3 or escutcheon, and a swivel pin 4 or handle spindle in the form of a square shank.

The handle plate 3, which constitutes an outer coupling member in the illustrative embodiment shown, comprises mounting holes 5 for receiving screws or the like with which it can be fixed to a door, a window, a gate, a hatch (not shown) or a similar element. The handle plate 3 further comprises a central through-hole 6, the centre axis of which defines an axis of rotation for the handle grip 1. Two opposite grooves 7a, 7b are made in the central hole 6 of the handle plate 3. The grooves 7a, 7b are formed as axially extending and radially outwardly curved recesses in the circumferential surface of the central hole 6.

A hub 10 is received in the handle neck 2. In the embodiment shown in the figures, the hub 10 constitutes an inner coupling member for achieving a selective disengagement and coupling of the handle grip 1 in relation to the handle plate 3. As is best illustrated in FIG. 2, the hub comprises two hub halves 11, 12, which together define an inner space arranged in the hub. The hub 10 has two opposite axial grooves 13 which cooperate with corresponding axial projections (not shown) arranged inside the handle neck in order to prevent the hub from being turned or rotating relative to the handle neck 2 and therefore relative to the handle grip 1. The hub is axially fixed relative to the handle neck and the handle grip by means of a locking ring (not shown), for example a retainer ring, which engages with radial grooves in the hub and the handle neck. The swivel pin 4 is fixed to the hub 10. Fixing in the direction of rotation is achieved by means of the hub having, at one end thereof, a recess with a cross-sectional shape corresponding to the cross section of the swivel pin. Fixing in the axial direction is achieved by means of a spring-loaded radial locking pin 14 which is formed in the swivel pin and which engages with a radial locking hole 15 in the hub 10.

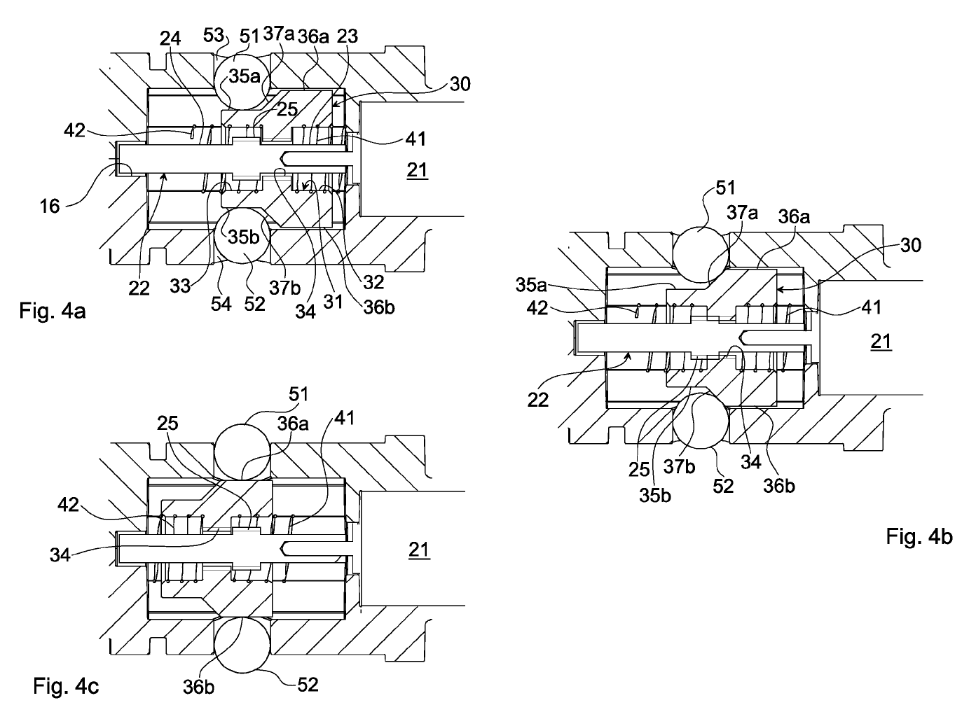

As can best be seen from FIGS. 2 and 4a-c, an electric motor 21 is received and fixed in the inner space of the hub 10. The motor is coupled to an output shaft 22 which, by driving the motor in rotation in either direction of rotation, is rotatable in corresponding directions. At one end, the shaft 22 is fixed to the motor shaft and, at the opposite end, is mounted in a recess 16 in the hub. The shaft has a first end portion 23, a second end portion 24 and, arranged between the first and second end portions, a threaded shaft portion 25. The threaded shaft portion 25 has a larger diameter than the two end portions 23, and is provided with an external thread. In the example shown, the external thread is of the type M3×0.35 mm. The axial length of the external thread is about 2.5 mm.

An activating member 30 is received in an axially movable manner in the inner space of the hub 10. The outer shape of the activating member 30 and the shape of the inner walls of the hub 10, which delimit the inner space, are designed such that the activating member 30 is fixed in rotation in the hub, i.e. the activating member can be moved axially but not turned relative to the hub 10. The activating member 30 has an axial and central continuous bore 31. The bore has a first end portion 32 and a second end portion 33 and, arranged between the first and second end portions, a thread engagement portion 34. The thread engagement portion 34 has a smaller internal diameter than the two end portions 32, 33. The thread engagement portion 34 is also provided with an internal thread which corresponds to the external thread on the threaded shaft portion 25 of the shaft 22. Like the external thread of the shaft 22, the internal thread of the thread engagement portion is of the type M3×0.35 mm. The axial length of the internal thread of the thread engagement portion is also substantially identical to the axial length of the external thread of the shaft 22.

A first spring member 41 and a second spring member 42 are arranged respectively in the first end portion 32 and second end portion 33 of the activating member 30. The two spring members 41, 42 consist of cylindrical compression springs. The nominal external diameters of the spring members 41, 42 are slightly greater than the internal diameter of the end portions 32, 33, such that the spring members 41, 42 are fixed on the activating member 30 by means of a push fit. The spring members 41, 42 protrude axially from the respective end portion 32, 33 of the bore 31, such that the spring members, bearing against respective end walls of the inner space of the hub 10, can be compressed when the activating member has adopted a respective end position by movement along the shaft 22.

The activating member 30 has radially opposite outer surfaces. These surfaces comprise two first surfaces 35a, 35b, which are arranged at a first distance from the centre axis of the activating member 30, two second surfaces 36a, 36b, which are arranged at a second distance, which second distance is greater than the first distance from the centre axis of the activating member, and two intermediate inclined surfaces 37a, 37b, which connect the first surfaces 35a, 35b to a respective second surface 36a, 36b.

A first engaging member 51 and a second engaging member 52, each in the form of a ball, are arranged in a radially movable manner in opposite radial cylindrical holes 53, 54 that are formed in the hub 10.

A keypad comprising four code buttons 61 and a lock button 62 is arranged on the handle grip in such a way that these buttons are easily accessible and make it possible, for example with the thumb, to enter an authorization code and, by pressing the lock button 62, to block the function of the handle. The keypad is electrically coupled to an electrical control circuit (not shown) that is received in the handle grip 1. The electrical control circuit is also electrically coupled to a battery (not shown) received in the handle grip and to the electric motor 21.

The function of the illustrative embodiment of the handle device shown in the figures will now be described below. In the position shown in FIG. 4a, the activating member 30 is located in a first end position. In the figures, this position is illustrated by the activating member 30 having adopted a position offset to the right. The thread engagement portion 34 of the activating member 30 is to the right of the threaded shaft portion 25 of the shaft 22, such that the internal thread on the activating member 30 is not in engagement with the external thread on the shaft 22. The first spring member 41 has adopted a compressed state between the activating member and a respective end wall of the hub 10. The spring member thus presses the activating member 30 towards the left in the figure. In this first end position of the activating member 30, the first surfaces 35a, 35b are opposite the radial holes 53, 54, and the balls bearing against these surfaces are located in a radially retracted position. In this position, the balls do not engage with the grooves 7a, 7b of the handle plate 3. The handle grip 1, the handle neck 2 and the swivel pin 4 are therefore free to be turned about the axis of rotation of the handle. By gripping the handle grip 1 and turning the latter, it is thus possible to manoeuvre an espagnolette, for example, or some other movable lock part that is coupled to the swivel pin 4 in the usual way.

In order to block or lock the handle device such that the handle grip cannot be used to manoeuvre the espagnolette or the like, a user quite simply presses the lock button 62. The electrical control circuit then sends a supply current, for rotation in a first direction of rotation, to the electric motor 21 for a predetermined period. During rotation of the shaft 22 in the first direction of rotation, the thread engagement portion 34 of the activating member 30 is brought into engagement with the threaded shaft portion 25 of the shaft 22, under the effect of the first spring member 41.

During continued rotation in the first direction of rotation, the activating member 30, by threaded engagement with the shaft 22, is then moved axially along the shaft, towards the left in the figures. During this axial movement of the activating member 30, the latter passes through the position illustrated in FIG. 4b. When the inclined surfaces 37a, 37b pass the radial holes 53, 54, these surfaces 37a, 37b come into contact with the balls 51, 52 and press the balls radially outwards in the holes 53, 54.

The predetermined time during which the motor is driven in the first direction of rotation is chosen such that the thread engagement portion 34 of the activating member 30 is safely driven along the whole of the threaded shaft portion 25 and past the latter. During rotation in the first direction of rotation, the activating member 30 therefore comes to adopt the second end position illustrated in FIG. 4c. In this end position, the thread engagement portion 34 of the activating member 30 has been disengaged from the threaded shaft portion 25 of the shaft 22. At the same time, the second spring member 42 has come to bear against the corresponding end wall of the hub 10 and has been compressed between the activating member 30 and this end wall. Continued rotation in the first direction of rotation therefore does not affect the position of the activating member 30. Instead, the activating member 30 is maintained in the well-defined second end position.

As can best be seen from FIG. 4c, the second surfaces 36a, 36b, in this second end position of the activating member 30, have adopted a position radially to the inside of the radial holes 53, 54. The balls 51, 52 have thus been pushed radially outwards to their respective engagement positions. In this position, the balls bear against the second surfaces 36a, 36b and cannot be pressed radially inwards. In the radially outwardly extended engagement position, the balls 51, 52 engage with a respective groove 7a, 7b in the handle plate 3. In this way, the handle grip 1, the handle neck 2 and the swivel pin 4 are blocked against being turned relative to the handle plate 3. The handle grip cannot therefore be used to manoeuvre an espagnolette, coupled to the swivel pin 4, or another movable lock part or the like. The handle device is therefore locked or blocked.

In order to unlock the handle device such that the handle grip can again be used for maneuvering, it is first of all necessary for a user to enter a correct authorization code via the code buttons 61. When this has been done, the electrical control circuit sends a supply current, for rotation in the other direction of rotation, to the electric motor 21 for a predetermined time. During rotation of the shaft 22 in the other direction of rotation, the thread engagement portion 34 of the activating member 30 is brought into engagement with the threaded shaft portion 25 of the shaft 22 under the effect of the second spring member 42.

During continued rotation in the other direction of rotation, the activating member 30, by threaded engagement with the shaft 22, is then moved axially along the shaft, towards the right in the figures. During this axial movement of the activating member 30, the latter again passes through the position illustrated in FIG. 4b. When the inclined surfaces 37a, 37b pass the radial holes 53, 54, the balls 51, 52 can be moved radially inwards in the holes 53, 54.

The predetermined time during which the motor is driven in the other direction of rotation is chosen such that the thread engagement portion 34 of the activating member 30 is safely driven along the whole of the threaded shaft portion 25 and past the latter. During rotation in the other direction of rotation, the activating member 30 therefore again comes to adopt the first end position illustrated in FIG. 4a. In this first end position of the activating member 30, the balls are free to be moved radially inwards to the positions shown in FIG. 4a. The upper ball 51 thus drops into the retracted position. As can be seen from FIG. 3, the grooves 7a, 7b in the handle plate 3 are designed with a certain curvature which, in conjunction with the curvature of the balls, contributes to pressing the two balls 51, 52 radially inwards when the hub 10, during maneuvering by means of the handle grip 1, is turned relative to the handle plate 3. This ensures that the balls are disengaged from the handle plate 3 when the activating member 30 has adopted its first end position and the handle grip 1 is duly to be used for maneuvering.

In one embodiment of the invention, the electrical control circuit is designed to measure the current or power consumption of the motor 21 during the movement of the activating member. If such a measurement finds that the current or power consumption exceeds a predetermined normal level, this indicates that the activating member 30 has been impeded during the movement towards the end position in question. For example, during movement towards the second end position, this could happen if, when the lock button 62 is pressed, the handle grip is not located in a position in which the balls 51, 52 are placed opposite the grooves 7a, 7b. The control circuit can therefore be designed in such a way that, if such an abnormal current or power consumption is detected, it repeatedly sends, a certain number of times, a supply current for driving the motor 21 in the direction of rotation corresponding to the intended movement of the activating member. If an abnormally high current or power consumption is detected even during the repeated attempts, the control circuit can indicate, for example by means of a light signal and/or acoustic signal, that the handle device has not adopted the intended position and that an error state exists. For those cases where the movement of the balls and/or of the activating member is impeded, for example by dust or foreign particles, it is possible that the control circuit is designed to drive the motor in rotation alternately in the first direction of rotation and second direction of rotation, for a certain period of time or for a certain number of cycles, when an abnormal current or power consumption is detected. This alternating operation of the motor can lead to the obstacle being eliminated, after which the activating member can be moved to the intended end position.

An advantage of the handle device according to the invention is that the electric motor for operating the activating member can be made very small and compact. A particular advantage is that the combined axial length of the motor and of the shaft can be kept to a minimum. In this way, it is possible to reduce the extent to which the handle device protrudes from the door, window or the like on which it is mounted. Another advantage is that the motor, even with modest power consumption, can generate the desired movement of the activating member in order to move the engaging members into and out of the engagement positions. In this way, the size of the power-supply battery can be kept to a minimum and/or the life of the battery can be extended.

In an embodiment not shown, the handle device can be designed to selectively permit coupling and disengagement between a first rotatable element and a second rotatable element. The first rotatable element can be a handle, and the second rotatable element can be a swivel pin that is coupled to a maneuvering rower in a lock housing, an espagnolette or the like. The swivel pin can comprise or be fixedly connected to an inner or outer coupling member, and the handle to a corresponding outer or inner coupling member, respectively. The two coupling members can be selectively coupled or disengaged by means of at least one radially movable engaging member which, by means of an activating member, shaft and motor of the type described above and arranged in the inner coupling member, can be driven in the radial direction for simultaneous engagement with the inner and outer coupling members. In such applications for coupling two rotatable elements, the handle device can be used to selectively provide coupling, in order to permit maneuvering, and disengagement, for so-called free swing.

Illustrative embodiments of the invention have been described above. However, it will be appreciated that the invention is not limited to these embodiments and can instead be freely modified within the scope of the attached claims. The figures illustrate an embodiment in which the handle comprises a handle grip and a handle neck. The illustrated handle is what is called a window handle, which can be turned between and held in two or more defined positions of rotation. This type of handle is suitable for the operation of, for example, espagnolettes or other types of multi-point locks that can advantageously be used on windows and patio doors. However, the handle device according to the invention can also be used in many other types of handles. Examples of other handles are lever handles that can be moved resiliently from a normal position to a maneuvering position. Such handle devices provided with a lever handle can advantageously be used when it is desirable to be able to lock and unlock internal doors without using a key. Another example is a handle knob or door knob, which often comprises a cylindrical or spherical grip part that can be coupled to a swivel pin and can be turned with or relative to a neck. In such applications, the handle device according to the invention can be used for selective coupling or disengagement between the grip part and the swivel pin or, if the grip part is rotatable relative to the neck, between the grip part and the neck.

Instead of being designed as balls, the engaging member or members can also have any other suitable form. An example of such an engaging member is an elongate pin which is arranged parallel to the direction of movement of the activating member and which preferably has a radially outwardly curved surface and conically narrowing ends. One or more such pins can be arranged in corresponding recesses in the inner coupling member and can be acted on by an axially movable activating member accommodated in the inner coupling member.

Instead of arranging an external thread on the shaft and a corresponding internal thread on the activating member, it is possible to form the shaft as a hollow cylinder with internal thread and to form the activating member with a thread engagement portion which is axially movable in the hollow cylinder and which has a corresponding external thread. It is also possible for the activating member to be arranged rectilinearly and movable parallel to and alongside the shaft, in which case the threaded portion of the shaft and also the thread engagement portion of the activating member are provided with external threads.

Instead of an authorization-verifying keypad connected to the control circuit for controlling the movement of the activating member, other devices can be used for verifying a user's authorization. Examples of such devices are so-called RFID devices which, by radio transmission, can read a coded identification card or a coded identification badge or the like, which a user holds up close to an RFID reader, which can preferably be placed in the handle grip. It is of course also possible to use a system with a so-called “i button”, in which the RFID reader is activated only when the identification badge is brought into physical contact with a contact surface connected to the RFID reader. Such an arrangement draws current only when the RFID reader is activated for reading, and it is therefore well suited for fitting in the handle grip where the limited space places a limit on the size of the current source that can be used. It is also possible for the control circuit to comprise an RF receiver for remote operation from a remote station, which communicates with the control circuit of the handle device via long-range radio waves.

As an alternative to the electrical control circuit being designed to drive the motor for a certain predetermined time, it is possible for the control circuit to be designed to drive the motor in rotation for a certain number of revolutions, for moving the activating member between the end positions. Such a configuration can be easily achieved, for example, if the motor is a stepping motor, or it can be achieved with the aid of other means known per se for counting the number of revolutions of the motor. With this kind of control too, it is still sufficient for the motor to be controlled with low precision as regards the number of revolutions that are to be made, since operation of the motor for a greater number of revolutions than is needed for complete movement of the activating member does not cause the activating member to be moved beyond its end position or cause the motor to be overloaded.

In the embodiments described above, the electric motor for driving the activating member is arranged in the handle grip that is to be able to be disengaged from and coupled to another part of the device. However, by virtue of the fact that the activating member moves axially, it is easy to control the activating member with a motor which is arranged, for example, in a handle grip, a knob or some other element fixed to the opposite side of the door on which the handle device is arranged. The axial activation movement means that it is easy, by using an axially movable member such as a bar or a shank centrally received in the handle spindle, to operate the activating member from either side of the door.

1. A handle device for operating doors, windows and the like comprising
a first element, which is rotatable about an axis of rotation,
a second element, and
a coupling device comprising an activating member, which is axially movable parallel to the axis of rotation; at least one engaging member which is configured to be moved radially by the activating member between a release position, in which the first and second elements are rotatable in relation to each other about the axis of rotation, and an engagement position, in which relative rotation between the first and second elements is prevented; and an electrical drive device for moving the activating member to and fro axially, wherein
the electrical drive device comprises an electrically driven motor with an output shaft rotatable in two opposite directions of rotation, which shaft comprises a first end portion and a second end portion and, arranged between the end portions, a threaded shaft portion with a first thread;
the activating member comprises a thread engagement portion having a second thread that corresponds to the first thread, which first and second threads are configured to drive the activating member axially along the shaft during thread engagement and rotation of the shaft; and
a first spring member and a second spring member are arranged to press the thread engagement portion of the activating member in a direction towards the threaded shaft portion of the shaft, when the second thread of the activating member has been disengaged from the first thread of the shaft by rotation of the shaft in a respective direction of rotation.

2. A handle device according to claim 1, in which the first thread is an external thread arranged on the threaded shaft portion, and the activating member has an axial bore, which receives the shaft and which, along the thread engagement portion, has the second thread in the form of an internal thread.

3. A handle device according to claim 1, in which the first spring member and second spring member each comprise a helical spring.

4. A handle device according to claim 1, in which the first spring member and second spring member are fixed, at a respective first end, to the activating member.

5. A handle device according to claim 1, in which the activating member and the shaft are accommodated in an inner coupling member, which is accommodated concentrically in an outer coupling member.

6. A handle device according to claim 5, in which the activating member is fixed in rotation in the inner coupling member.

7. A handle device according to claim 5, in which the first element is a handle grip, which is fixed to the inner coupling member, and the second element is a handle plate, which constitutes or is fixed to the outer coupling member.

8. A handle device according to claim 5, in which the first element is a handle grip, which constitutes or is fixed to the outer coupling member, and the second element is a rotatable swivel pin, which constitutes or is fixed to the inner coupling member.

9. A handle device according to claim 1, in which the at least one engaging member consists of a ball.

10. A handle device according to claim 1, in which the activating member has at least one surface which is inclined with respect to the axial direction of movement thereof and which, in contact with the engaging member, presses the latter radially outwards when the activating member is moved axially.

11. A handle device according to claim 1, comprising an electrical control circuit for controlling the electric motor.

12. A handle device according to claim 11, in which the electrical control circuit is designed to drive the electric motor in rotation in a respective direction of rotation for a predetermined time which time corresponds to the movement of the activating member between a first end position and a second end position of the activating member.

13. A handle device according to claim 11, in which the electrical control circuit comprises means for measuring the current or power consumption of the electric motor.

14. A handle device according to claim 11, in which the electrical control circuit comprises authorization-verifying means, preferably a keypad, which is electrically connected to the control circuit.
